(19) United States
(12) Patent Application Publication
(10) Pub. No.: US 2009/0098456 A1
(43) Pub. Date: Apr. 16, 2009

(54) Non-aqueous electrolyte solution and lithium secondary battery including the same

(76) Inventors: Myung Kook PARK, Gumi-Si (KR); Jung Kang OH, Gumi-Si (KR); Ho Seok YANG, Seo-gu (KR)

Correspondence Address: LEE & MORSE, P.C., 3141 FAIRVIEW PARK DRIVE, SUITE 500, FALLS CHURCH, VA, 22042, US

(21) Appl. No.: 11/907,583

(22) Filed: Oct. 15, 2007

(51) Int. Cl. H01M 6/04

(52) U.S. Cl. 429/200; 429/188

(57) ABSTRACT

A non-aqueous electrolyte solution, including a lithium salt, an organic solvent, one or more succinic acid anhydride compounds, and one or more trialkylsilyl borate compounds.

### BACKGROUND OF THE INVENTION

1. Field of the Invention

Embodiments relate to a non-aqueous electrolyte solution and a secondary battery including the same and, more particularly, to a non-aqueous electrolyte solution that may include succinic acid anhydride compounds such as succinic acid anhydride, maleic acid anhydride, and/or substituted derivatives thereof, and a trialkylsilyl borate such as trimethylsilyl borate, which may be applied to a lithium secondary battery.

2. Description of the Related Art

Secondary batteries, i.e., rechargeable batteries, have become popular for portable electronic devices such as notebook computers, mobile communication devices, digital cameras, etc., which has brought about an exponential increase in the market for secondary batteries. Thus, secondary batteries, together with semiconductors and displays, have become one of leading component industries in the 21^{st} century.

Secondary batteries may include, e.g., lead acid batteries, nickel cadmium (Ni—Cd) batteries, nickel-metal hydride (Ni-MH) batteries and lithium (Li) batteries, which are generally referred to based on the materials used therein for negative or positive electrodes. Of these, lithium secondary batteries are popular because they may exhibit a high energy density due to low oxidation/reduction electrical potential and low molecular weight. Lithium secondary batteries may employ a non-aqueous electrolyte solution, a positive electrode that reversibly intercalates or deintercalate lithium ions, and a negative electrode. The non-aqueous electrolyte solution may serve as a medium enabling lithium ions to flow from the positive electrode to the negative electrode. The electrolyte solution should exhibit stability at a battery operation voltage and transport lithium ions at a high rate.

Non-aqueous electrolyte solutions generally include an organic solvent, which in some cases may decompose. For example, a carbonate-based organic solvent may decompose during a SEI film-forming reaction (a “solid electrolyte interface” film, a kind of passivation thin film, which may be formed on the surface of the negative electrode) or charging of the lithium secondary battery. The non-aqueous electrolyte solution may also be decomposed by a side reaction thereof with the positive or negative electrode. Decomposition of the organic solvent may release gas, e.g., CO, CO₂, CH₄, C₂H₆, etc., which may in turn cause an undesired increase in the thickness, i.e., swelling, of the battery, may significantly deteriorate the discharge capacity and lifespan of the battery, and may increase the internal resistance of the battery with the passage of time.

### SUMMARY OF THE INVENTION

Embodiments are directed to a non-aqueous electrolyte solution and secondary battery including the same, which substantially overcome one or more of the problems due to the limitations and disadvantages of the related art.

It is therefore a feature of an embodiment to provide a non-aqueous electrolyte solution that may include succinic acid anhydride, maleic acid anhydride, and/or substituted compounds thereof, and a trialkylsilyl borate such as trimethylsilyl borate.

It is therefore another feature of an embodiment to provide a secondary battery including the non-aqueous electrolyte solution.

At least one of the above and other features and advantages of the present invention may be realized by providing a non-aqueous electrolyte solution, including a lithium salt, an organic solvent, one or more succinic acid anhydride compounds, and one or more trialkylsilyl borate compounds.

The one or more succinic acid anhydride compounds may include a compound represented by Structure 1:

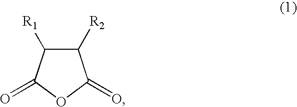

wherein R₁ and R₂ may be same or different, R₁ may be hydrogen, halogen, or C₁-C₁₀ alkyl, C₁-C₁₀ alkenyl or C₁-C₁₀ alkoxy, each unsubstituted or substituted with at least one halogen, and R₂ may be hydrogen, halogen, or C₁-C₁₀ alkyl, C₁-C₁₀ alkenyl or C₁-C₁₀ alkoxy, each unsubstituted or substituted with at least one halogen.

The one or more succinic acid anhydride compounds may further include a compound represented by Structure 2:

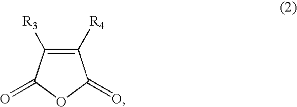

wherein R₃ and R₄ may be the same or different, R₃ may be hydrogen, halogen, or C₁-C₁₀ alkyl, C₁-C₁₀ alkenyl or C₁-C₁₀ alkoxy, each unsubstituted or substituted with at least one halogen, and R₄ may be hydrogen, halogen, or C₁-C₁₀ alkyl, C₁-C₁₀ alkenyl or C₁-C₁₀ alkoxy, each unsubstituted or substituted with at least one halogen.

The one or more trialkylsilyl borate compounds may include trimethylsilyl borate. A ratio of a total weight of the one or more succinic acid anhydride compounds to a total weight of the one or more trialkylsilyl borate compounds may be about 1:1. The organic solvent may include one or more of dimethyl carbonate, diethyl carbonate, ethylpropyl carbonate, dipropyl carbonate, methylethyl carbonate, methylpropyl carbonate, ethylene carbonate, propylene carbonate, butylene carbonate, and/or vinylene carbonate. The organic solvent may further include one or more of an ester-based solvent, an ether-based solvent, a ketone-based solvent and/or an aromatic hydrocarbon solvent. A ratio of a weight of the organic solvent to a total weight of the one or more succinic acid anhydride compounds and the one or more trialkylsilyl borate compounds may be about 0.01:100 to about 10:100. The lithium salt may be present in a concentration of about 0.6 M to about 2.0 M with respect to the organic solvent.

At least one of the above and other features and advantages of the present invention may be realized by providing a lithium secondary battery, including a housing, and a positive electrode, a negative electrode, and a non-aqueous electrolyte solution disposed in the housing. The non-aqueous electrolyte solution may include a lithium salt, an organic solvent, one or more succinic acid anhydride compounds, and one or more trialkylsilyl borate compounds.

The one or more succinic acid anhydride compounds may include a compound represented by Structure 1:

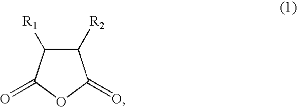

wherein R₁ and R₂ may be the same or different, R₁ may be hydrogen, halogen, or C₁-C₁₀ alkyl, C₁-C₁₀ alkenyl or C₁-C₁₀ alkoxy, each unsubstituted or substituted with at least one halogen, and R₂ may be hydrogen, halogen, or C₁-C₁₀ alkyl, C₁-C₁₀ alkenyl or C₁-C₁₀ alkoxy, each unsubstituted or substituted with at least one halogen.

The one or more succinic acid anhydride compounds may further include a compound represented by Structure 2:

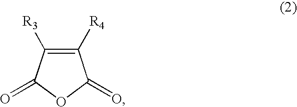

wherein R₃ and R₄ may be the same or different, R₃ may be hydrogen, halogen, or C₁-C₁₀ alkyl, C₁-C₁₀ alkenyl or C₁-C₁₀ alkoxy, each unsubstituted or substituted with at least one halogen, and R₄ may be hydrogen, halogen, or C₁-C₁₀ alkyl, C₁-C₁₀ alkenyl or C₁-C₁₀ alkoxy, each unsubstituted or substituted with at least one halogen.

The one or more trialkylsilyl borate compounds may include trimethylsilyl borate. A ratio of a total weight of the one or more succinic acid anhydride compounds to a total weight of the one or more trialkylsilyl borate compounds may be about 1:1. The organic solvent may include one or more of dimethyl carbonate, diethyl carbonate, ethylpropyl carbonate, dipropyl carbonate, methylethyl carbonate, methylpropyl carbonate, ethylene carbonate, propylene carbonate, butylene carbonate, and/or vinylene carbonate. The organic solvent may further include one or more of an ester-based solvent, an ether-based solvent, a ketone-based solvent and/or an aromatic hydrocarbon solvent. A ratio of a weight of the organic solvent to a total weight of the one or more succinic acid anhydride compounds and the one or more trialkylsilyl borate compounds may be about 0.01:100 to about 10:100. The lithium salt may be present in a concentration of about 0.6 M to about 2.0 M with respect to the organic solvent.

### BRIEF DESCRIPTION OF THE DRAWINGS

The above and other features and other advantages of the present invention will become more apparent to those of ordinary skill in the art by describing in detail exemplary embodiments thereof with reference to the attached drawings, in which:

FIG. 1 illustrates a schematic diagram of a lithium secondary battery including a non-aqueous electrolyte solution according to an embodiment; and

FIG. 2 illustrates a graph of lifespans of batteries produced in accordance with Examples 1-5 and Comparative Examples 1-3.

### DETAILED DESCRIPTION OF THE INVENTION

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer, it can be directly on the other layer, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include a fourth member, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

As used herein, “succinic acid anhydride compounds” includes succinic acid anhydride and substituted derivatives thereof, and further includes maleic acid anhydride and substituted derivatives thereof, unless expressly indicated otherwise.

An embodiment is directed to a non-aqueous electrolyte solution, which may include a lithium salt, an organic solvent, and an additive. The additive may include one or more succinic acid anhydride compounds and one or more trialkylsilyl borate compounds.

In an implementation, the additive may include a mixture of one or more succinic acid anhydride compounds represented by Structures 1 and/or 2, i.e., Structure 1, Structure 2, or a mixture thereof:

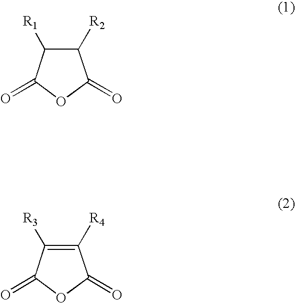

In Structure 1, R₁ and R₂ may be same or different, and may each independently be hydrogen, halogen, or C₁-C₁₀ alkyl, C₁-C₁₀ alkenyl or C₁-C₁₀ alkoxy, each unsubstituted or substituted with at least one halogen. That is, the C₁-C₁₀ alkyl may be an alkane moiety that is unsubstituted, or substituted with at least one halogen, the C₁-C₁₀ alkenyl may be an alkene moiety that is unsubstituted, or substituted with at least one halogen, and the C₁-C₁₀ alkoxy may be an alkoxy moiety that is unsubstituted, or may be substituted with at least one halogen.

In Structure 2, R₃ and R₄ may be the same or different, and may each independently be hydrogen, halogen, or C₁-C₁₀ alkyl, C₁-C₁₀ alkenyl or C₁-C₁₀ alkoxy, each unsubstituted or substituted with at least one halogen.

An example trialkylsilyl borate compound is trimethyl borate, represented by Structure 3:

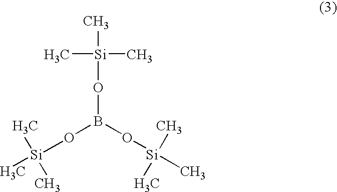

Another embodiment is directed to a lithium secondary battery, which may include a housing, and a positive electrode, a negative electrode, and the non-aqueous electrolyte solution disposed in the housing.

In an implementation, the battery may include an electrode part having a positive electrode and a negative electrode, the positive and the negative electrodes facing each other with the non-aqueous electrolyte solution therebetween. The battery may include a separator for physically separating the positive electrode from the negative electrode, while allowing ions to pass therethrough.

As described above, in an implementation, the non-aqueous electrolyte solution may include a lithium salt, an organic solvent, and an additive including a mixture of one or more succinic acid anhydride compounds represented by Structures 1 and/or 2 with a trialkylsilyl borate represented by Structure 3. The additive may function to prevent decomposition of the electrolyte solution, which may otherwise be caused by a side reaction thereof with materials used for the positive or negative electrode during charging of a lithium secondary battery. The additive may also reduce or eliminate undesired gas generation resulting from the decomposition. Accordingly, discharge capacity and lifespan of the battery may be improved, and an undesired increase in the thickness of the battery, i.e., swelling of the housing, due to gas generation may thus be reduced or avoided.

Component of the non-aqueous electrolyte solution will be now be explained in additional detail.

As described above, the non-aqueous electrolyte solution may include an organic solvent. The organic solvent may be water free. The organic solvent may be a single compound or a mixture. The organic solvent used in the non-aqueous electrolyte solution may include, e.g., one or more of carbonate-based solvents, ester-based solvents, ether-based solvents, ketone-based solvents, aromatic hydrocarbon solvents, etc. In an implementation, the organic solvent may include a mixture of a carbonate-based solvent with one or more of ester-based solvents, ether-based solvents, ketone-based solvents and/or aromatic hydrocarbon solvents.

Carbonate-based solvents may include, e.g., linear carbonates such as dimethyl carbonate (DMC), diethyl carbonate (DEC), ethylpropyl carbonate (EPC), dipropyl carbonate (DPC), methylethyl carbonate (MEC) and methylpropyl carbonate (MPC), and cyclic carbonates such as ethylene carbonate (EC), propylene carbonate (PC), butylene carbonate (BC) and vinylene carbonate (VC).

The cyclic carbonate-based solvent may be very effective to dissolve lithium ions owing to its high polarity, but may exhibit a relatively low ion-conductivity due to its high viscosity. Therefore, the use of a mixture of a cyclic carbonate solvent with a linear carbonate solvent, which may have a low polarity and low viscosity, as an organic solvent of the non-aqueous electrolyte solution may help optimize the characteristics of the lithium secondary battery.

Examples of the above-described ester-based solvents include, e.g., butyrolactone (BL), decanolide, valerolactone, mevalonolactone, caprolactone, methyl propionic acid, ethyl propionic acid, n-methyl acetate, n-ethyl acetate, n-propyl acetate and n-butyl acetate. An example of the above-described ether-based solvent is dibutyl ether. Examples of the above-described aromatic hydrocarbon-based solvents include, e.g., benzene, fluorobenzene, toluene, fluorotoluene, trifluorotoluene and xylene. As described above, the solvents and may be used alone or in a combination thereof.

In an implementation, the organic solvent may include a mixture of a carbonate-based solvent with an aromatic hydrocarbon-based solvent, and the carbonate-based solvent and the aromatic hydrocarbon-based solvent may be used in a volume ratio of about 1:1 to about 30:1.

As described above, the non-aqueous electrolyte solution may further include a lithium salt as a solute. The lithium salt may include one or more of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CxF₂ₓ₊₁SO₂)(CyF₂y+1SO₂) (wherein x and y are each independently a positive integer), LiCl, and/or LiI.

The lithium salt may be included in the non-aqueous electrolyte solution in a concentration of about 0.6 M to about 2.0 M with respect to the organic solvent.

The use of the lithium salt in a concentration more than about 0.6 M may improve a electrical conductivity of the electrolyte solution in which the lithium salt is contained, thus leading to a improvement in the performance of the non-aqueous electrolyte solution so that it may be capable of rapidly transporting lithium ions from a positive electrode to a negative electrode. The use of the lithium salt in a concentration of less 2.0 M may avoid an undue increase in viscosity of the electrolyte solution, which could lead to a reduction in the mobility of lithium ions and a deterioration in the low-temperature performance of the battery.

As described above, the non-aqueous electrolyte solution may include an additive in addition to the organic solvent and the lithium salt. The additive may be a mixture of one or more succinic acid anhydride compounds and one or more trialkylsilyl borate compounds. Further, as described above, an example of a succinic acid anhydride compound may be succinic acid anhydride itself, or a derivative, as represented by Structure 1:

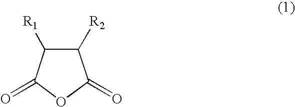

As described above, in Structure 1, R₁ and R₂ may be same or different, R₁ may be hydrogen, halogen, or C₁-C₁₀ alkyl, C₁-C₁₀ alkenyl or C₁-C₁₀ alkoxy, each unsubstituted or substituted with at least one halogen, and R₂ may be hydrogen, halogen, or C₁-C₁₀ alkyl, C₁-C₁₀ alkenyl or C₁-C₁₀ alkoxy, each unsubstituted or substituted with at least one halogen.

Another example of a succinic acid anhydride compound may be maleic acid anhydride itself, or a derivative, as represented by Structure 2:

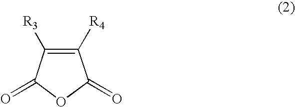

As described above, in Structure 2, R₃ and R₄ may be the same or different, R₃ may be hydrogen, halogen, or C₁-C₁₀ alkyl, C₁-C₁₀ alkenyl or C₁-C₁₀ alkoxy, each unsubstituted or substituted with at least one halogen, and R₄ may be hydrogen, halogen, or C₁-C₁₀ alkyl, C₁-C₁₀ alkenyl or C₁-C₁₀ alkoxy, each unsubstituted or substituted with at least one halogen.

As described above, the trialkylsilyl borate may include trimethylsilyl borate, as represented by Structure 3:

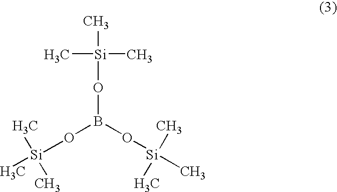

The additive, i.e., the mixture of the one or more succinic acid anhydride compounds and the trialkylsilyl borate, may be used in an amount of about 0.01 to about 10 parts by weight, more preferably 0.05 to 7.0 parts by weight, and most preferably 0.1 to 2.0 parts by weight, based on 100 parts by weight of the organic solvent.

When the additive is include in an amount of more than about 0.01 parts by weight, an improvement in the characteristics, e.g., discharge capacity or lifespan, of the battery may be significant. Such improvements may be offset by other factors if the additive is used in an amount of more than about 10 parts by weight.

Hereinafter, the action of an example additive in the non-aqueous electrolyte solution will be described in greater detail.

As described in the following Examples, a mixture of a succinic acid anhydride derivative and trimethylsilyl borate may reduce or prevent an occurrence of a side reaction of the electrolyte solution with the positive or negative electrode during charging of the lithium secondary battery. As a result, decomposition of the electrolyte solution, or generation of gases, e.g., CO, CO₂, CH₄, or C₂H₆, inside the battery, which may be caused by the side reaction, may be reduced. Therefore, the inclusion of the additive in the non-aqueous electrolyte solution may enables an efficient improvement of discharge capacitance and lifespan properties, while reducing or eliminating swelling of the battery caused by the gas generation.

The non-aqueous electrolyte solution may exhibit stability over a wide range of temperatures, e.g., −20° C. to 60° C., and may maintain its stability even at a voltage of 4V, which may enhance the stability and reliability of the lithium secondary battery. Thus, the non-aqueous electrolyte solution may be suitable for various applications such as lithium ion batteries, lithium polymer batteries, etc.

As described above, the non-aqueous electrolyte solution may be employed in a lithium secondary battery. In an implementation, the lithium secondary battery may include the non-aqueous electrolyte, an electrode part having a positive electrode and a negative electrode, the positive and negative electrodes facing each other with the non-aqueous electrolyte solution therebetween, and a separator for physically isolating the positive electrode from the negative electrode while permitting ions to pass therethrough.

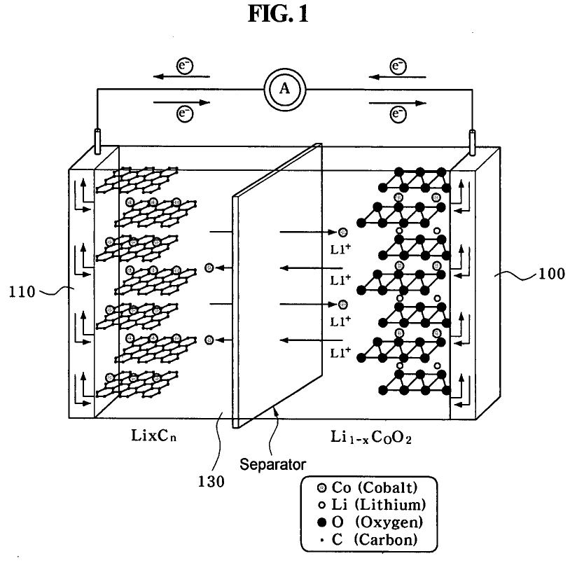

FIG. 1 illustrates a schematic diagram of a lithium secondary battery including a non-aqueous electrolyte solution according to an embodiment. Referring to FIG. 1, in an implementation, the battery may include a positive electrode 100, a negative electrode 110, and the non-aqueous electrolyte solution used as an electrolyte solution 130. A separator 140 may be provided between the positive electrode 100 and the negative electrode 110. The battery may be implemented as a prismatic battery, a cylindrical battery, etc. As the non-aqueous electrolyte solution used as the electrolyte solution 130 for the lithium secondary battery has been explained above, a further description thereof will not be repeated.

The positive electrode 100 may be formed of a metal, e.g., aluminum, coated with a positive active material. LiCoO₂ may be used as an active material for the positive electrode in the battery, as shown in FIG. 1. Further, other positive active materials may be used, e.g., lithium metal oxides such as LiCoO₂, LiMnO₂, LiMn₂O₄, LiNiO₂ and LiN_{1-x-y}COₓM_{y}O₂ (wherein 0≦x≦1, 0≦y≦1, 0≦x+y≦1, and M represents Al, Sr, Fe or La), a lithium intercalation compound such as a lithium chalcogenide, etc.

The negative electrode 110 may be formed of metal, e.g., copper, coated with a negative active material. Carbon (C), e.g., crystalline or amorphous carbon, may be used as an active material for the negative electrode in the lithium secondary battery of FIG. 1. Further, other negative active materials may be used, e.g., a carbon composite, lithium metal, lithium alloy, etc.

The metal used for the positive electrode 100 and the negative electrode 110 may receive a voltage from an external source during charging, and may supplies a voltage to the outside during discharging. The positive active material may collect positive charges, and the negative active material may collect negative charges.

The separator 140 may physically isolate the positive electrode from the negative electrode, thus preventing an electrical short circuit, while allowing charge carriers (ions) to pass therethrough. The separator 140 may be, e.g. a single-layered separator formed of polyethylene (PE) or polypropylene (PP); a double-layered separator formed of PE/PP; a triple-layered separator formed of PE/PP/PE or PP/PE/PP, etc.

Hereinafter, particular implementations will be described in detail with reference to the following Examples. These Examples are provided only for illustrating the above-described embodiments and are not be construed as limiting the scope and sprit of the present invention as set forth in the appended claims.

### EXAMPLES

### Example 1

LiCoO₂ as a positive active material, polyvinylidene fluoride (PVDF) as a binder, and carbon as a conductive agent were mixed at a weight ratio of 92:4:4. Then, the mixture was dispersed in N-methyl-2-pyrrolidone to prepare a positive electrode slurry. The slurry was coated on an aluminum foil with a thickness of 20 μm, followed by drying and compressing, to produce a positive electrode.

Artificial crystalline graphite as a negative active material and polyvinylidene fluoride (PVDF) as a binder were mixed at a weight ratio of 92:8. Then, the mixture was dispersed in N-methyl-2-pyrrolidone to prepare a negative electrode slurry. The slurry was coated on a copper foil with a thickness of 15 μm, followed by drying and compressing, to produce a negative electrode.

The resulting positive and negative electrodes were wound and pressed using a polyethylene separator having a thickness of 16 μm, and were placed into a prismatic can, i.e., housing, having dimensions of 30 mm×48 mm×6 mm.

1 M LiPF₆ (lithium salt) in a non-aqueous mixed solvent of ethylene carbonate, methylethyl carbonate and diethyl carbonate at a volume ratio of 1:1:1 was prepared as a preliminary electrolyte solution. To the preliminary electrolyte solution was added 0.05 parts by weight of a mixture of succinic acid anhydride and trimethylsilyl borate, based on 100 parts by weight of the preliminary electrolyte solution, to prepare a non-aqueous electrolyte solution.

### Example 2

A prismatic lithium secondary battery was produced in the same manner as in Example 1, except that a non-aqueous electrolyte solution was prepared from 0.5 parts by weight of a mixture of a succinic acid anhydride and trimethylsilyl borate, based on 100 parts by weight of the preliminary electrolyte solution.

### Example 3

A prismatic lithium secondary battery was produced in the same manner as in Example 1, except that a non-aqueous electrolyte solution was prepared from 1.0 part by weight of a mixture of a succinic acid anhydride and trimethylsilyl borate, based on 100 parts by weight of the preliminary electrolyte solution.

### Example 4

A prismatic lithium secondary battery was produced in the same manner as in Example 1, except that a non-aqueous electrolyte solution was prepared from 2.0 parts by weight of a mixture of succinic acid anhydride and trimethylsilyl borate, based on 100 parts by weight of the preliminary electrolyte solution.

### Example 5

A prismatic lithium secondary battery was produced in the same manner as in Example 1, except that a non-aqueous electrolyte solution was prepared from 5.0 parts by weight of a mixture of a succinic acid anhydride and trimethylsilyl borate, based on 100 parts by weight of the preliminary electrolyte solution.

### Comparative Example 1

A prismatic lithium secondary battery was produced in the same manner as in Example 1, except that the preliminary electrolyte solution alone, i.e., containing no succinic acid anhydride and trimethylsilyl borate additive, was used as a non-aqueous electrolyte solution.

### Comparative Example 2

A prismatic lithium secondary battery was produced in the same manner as in Example 1, except that 2.0 parts by weight of succinic acid anhydride alone was used, without trimethylsilyl borate, to prepare a non-aqueous electrolyte solution.

### Comparative Example 3

A prismatic lithium secondary battery was produced in the same manner as in Example 1, except that 2.0 parts by weight of trimethylsilyl borate alone was used, without succinic acid anhydride, to prepare a non-aqueous electrolyte solution.

### Testing

The charge/discharge performance and lifespan characteristics of prismatic lithium secondary batteries produced using the non-aqueous electrolyte solutions respectively prepared in Examples 1 to 5 and Comparative Examples 1 to 3 were tested by repeating 500 or more cycles of charging/discharging.

In the charge/discharge test, initial charging/discharging was carried out at a 0.2 C-rate up to 3.0 to 4.2 V, and charging/discharging was then carried out at a 1.0 C-rate up to 3.0 to 4.2 V in each cycle.

The charge and discharge tests were carried out under the conditions of constant current-constant voltage (CC-CV) and constant current (CC), respectively.

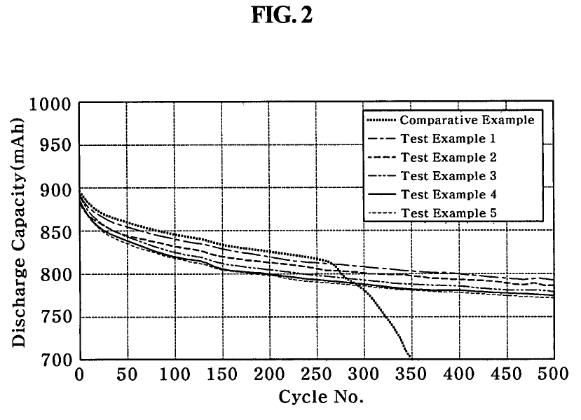

The results are shown in Table 1 and FIG. 2.

TABLE 1

| | Content (parts by weight*) | | | Capacity (mAh) | | | |
|---|---|---|---|---|---|---|---|
| | | | SA- | 100 | 300 | 500 | 800 |
| | SA | TMSB | TMSB | cycles | cycles | cycles | cycles |
| Ex. 1 | 0.025 | 0.025 | 0.05 | 845 | 807 | 793 | 478 |
| Ex. 2 | 0.25 | 0.25 | 0.5 | 835 | 802 | 787 | 524 |
| Ex. 3 | 0.5 | 0.5 | 1 | 827 | 794 | 780 | 612 |
| Ex. 4 | 1 | 1 | 2 | 822 | 783 | 776 | 668 |
| Ex. 5 | 2.5 | 2.5 | 5 | 820 | 782 | 775 | 724 |
| Comp. | 0 | 0 | 0 | 847 | 770 | 450 | — |
| Ex. 1 | | | | | | | |
| Comp. | 2 | 0 | 2 | 753 | 732 | 630 | 422 |
| Ex. 2 | | | | | | | |
| Comp. | 0 | 2 | 2 | 852 | 812 | 548 | — |
| Ex. 3 | | | | | | | |

Note:
In Table 2, parts by weight is determined based on the weight of the non-aqueous mixed solvent, SA indicates succinic acid anhydride, and TMSB indicates trimethylsilyl borate.

Comparing Example 4 to Comparative Examples 2 and 3, wherein each had a total amount of an additive being the same at 2.0 parts by weight, the data in Table 1 shows that the lithium secondary battery of Example 4, where a mixture of succinic acid anhydride and trimethylsilyl borate was used, exhibited superior lifespan characteristics of electric capacity. In particular, Example 4 exhibited superior characteristics after 300 cycles of charging/discharging as compared to the use of succinic acid anhydride exclusively (Comparative Example 2) or trimethylsilyl borate exclusively (Comparative Example 3).

More specifically, in Example 4, lifespan of electric capacity only slightly decreased with increasing charging/discharging cycles (300, 500 and 800 cycles), whereas, in Comparative Examples 2 and 3, lifespan characteristics of electric capacity rapidly decreased after 300 cycles of charging/discharging.

Referring to FIG. 2, a capacity retention ratio of each lithium secondary battery was obtained by calculating a ratio of a discharge capacity to an average charge capacity.

As shown in FIG. 2, the discharge capacity of lithium secondary batteries in the Comparative Example, where no mixture of succinic acid anhydride and trimethylsilyl borate was used, rapidly dropped at about 270 cycles of charging/discharging and was exhausted after 350 cycle of charging/discharging. In contrast, the lithium secondary batteries of Examples 1 to 5, where a mixture of succinic acid anhydride and trimethylsilyl borate was used as an additive, did not exhibit such a rapid drop and maintained up to 500 or more cycles of charging/discharging. Thus, it is apparent that the non-aqueous electrolyte solution according to an embodiment, wherein the mixture of succinic acid anhydride and trimethylsilyl borate was employed as an additive, provided an improved discharge capacity and lifespan for the lithium secondary battery. Without intending to be bound by theory, it is believed that the effectiveness of the non-aqueous electrolyte solution including the mixture of succinic acid anhydride and trimethylsilyl borate is because the mixture of succinic acid anhydride and trimethylsilyl borate contributes to preventing side reactions of the non-aqueous electrolyte solution with the positive or negative electrode and/or decomposition of the non-aqueous electrolyte solution caused by the side reactions during charging of the lithium secondary battery.

As apparent from the foregoing, a non-aqueous electrolyte solution for a lithium secondary battery according to the above-described embodiments may impart improved discharge capacity over time of use, good charge/discharge performance and prolonged lifespan to a lithium secondary battery. Accordingly, the lithium secondary battery may exhibit improved performance and prolonged lifespan.

Exemplary embodiments have been disclosed herein, and although specific terms are employed, they are used and are to be interpreted in a generic and descriptive sense only and not for purpose of limitation. For example, other suitable solvents, lithium salts, positive active materials, negative active materials etc., than those described above may also be used. Accordingly, it will be understood by those of ordinary skill in the art that various changes in form and details may be made without departing from the spirit and scope of the present invention as set forth in the following claims.

What is claimed is:

1. A non-aqueous electrolyte solution, comprising:
a lithium salt;
an organic solvent;
one or more succinic acid anhydride compounds; and
one or more trialkylsilyl borate compounds.

2. The solution as claimed in claim 1, wherein the one or more succinic acid anhydride compounds includes a compound represented by Structure 1: 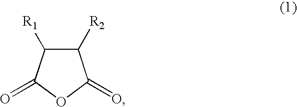
wherein:
R₁ and R₂ are the same or different,
R₁ is hydrogen, halogen, or C₁-C₁₀ alkyl, C₁-C₁₀ alkenyl or C₁-C₁₀ alkoxy, each unsubstituted or substituted with at least one halogen, and
R₂ is hydrogen, halogen, or C₁-C₁₀ alkyl, C₁-C₁₀ alkenyl or C₁-C₁₀ alkoxy, each unsubstituted or substituted with at least one halogen.

3. The solution as claimed in claim 2, wherein the one or more succinic acid anhydride compounds further includes a compound represented by Structure 2: 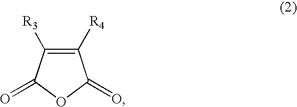
wherein:
R₃ and R₄ are the same or different,
R₃ is hydrogen, halogen, or C₁-C₁₀ alkyl, C₁-C₁₀ alkenyl or C₁-C₁₀ alkoxy, each unsubstituted or substituted with at least one halogen, and
R₄ is hydrogen, halogen, or C₁-C₁₀ alkyl, C₁-C₁₀ alkenyl or C₁-C₁₀ alkoxy, each unsubstituted or substituted with at least one halogen.

4. The solution as claimed in claim 1, wherein the one or more succinic acid anhydride compounds includes a compound represented by Structure 2: 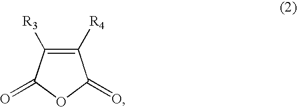
wherein:
R₃ and R₄ are the same or different,
R₃ is hydrogen, halogen, or C₁-C₁₀ alkyl, C₁-C₁₀ alkenyl or C₁-C₁₀ alkoxy, each unsubstituted or substituted with at least one halogen, and
R₄ is hydrogen, halogen, or C₁-C₁₀ alkyl, C₁-C₁₀ alkenyl or C₁-C₁₀ alkoxy, each unsubstituted or substituted with at least one halogen.

5. The solution as claimed in claim 1, wherein the one or more trialkylsilyl borate compounds includes trimethylsilyl borate.

6. The solution as claimed in claim 1, wherein a ratio of a total weight of the one or more succinic acid anhydride compounds to a total weight of the one or more trialkylsilyl borate compounds is about 1:1.

7. The solution as claimed in claim 1, wherein the organic solvent includes one or more of dimethyl carbonate, diethyl carbonate, ethylpropyl carbonate, dipropyl carbonate, methylethyl carbonate, methylpropyl carbonate, ethylene carbonate, propylene carbonate, butylene carbonate, and/or vinylene carbonate.

8. The solution as claimed in claim 7, wherein the organic solvent further includes one or more of an ester-based solvent, an ether-based solvent, a ketone-based solvent and/or an aromatic hydrocarbon solvent.

9. The solution as claimed in claim 1, wherein a ratio of a weight of the organic solvent to a total weight of the one or more succinic acid anhydride compounds and the one or more trialkylsilyl borate compounds is about 0.01:100 to about 10:100.

10. The solution as claimed in claim 1, wherein the lithium salt is present in a concentration of about 0.6 M to about 2.0 M with respect to the organic solvent.

11. A lithium secondary battery, comprising:
a housing; and
a positive electrode, a negative electrode, and a non-aqueous electrolyte solution disposed in the housing, wherein the non-aqueous electrolyte solution includes:
a lithium salt,
an organic solvent,
one or more succinic acid anhydride compounds, and
one or more trialkylsilyl borate compounds.

12. The battery as claimed in claim 11, wherein the one or more succinic acid anhydride compounds includes a compound represented by Structure 1: 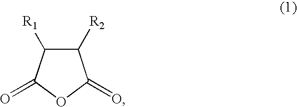
wherein:
R₁ and R₂ are the same or different,
R₁ is hydrogen, halogen, or C₁-C₁₀ alkyl, C₁-C₁₀ alkenyl or C₁-C₁₀ alkoxy, each unsubstituted or substituted with at least one halogen, and
R₂ is hydrogen, halogen, or C₁-C₁₀ alkyl, C₁-C₁₀ alkenyl or C₁-C₁₀ alkoxy, each unsubstituted or substituted with at least one halogen.

13. The battery as claimed in claim 12, wherein the one or more succinic acid anhydride compounds further includes a compound represented by Structure 2: 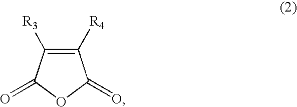
wherein:
R₃ and R₄ are the same or different,
R₃ is hydrogen, halogen, or C₁-C₁₀ alkyl, C₁-C₁₀ alkenyl or C₁-C₁₀ alkoxy, each unsubstituted or substituted with at least one halogen, and
R₄ is hydrogen, halogen, or C₁-C₁₀ alkyl, C₁-C₁₀ alkenyl or C₁-C₁₀ alkoxy, each unsubstituted or substituted with at least one halogen.

14. The solution as claimed in claim 11, wherein the one or more succinic acid anhydride compounds includes a compound represented by Structure 2: 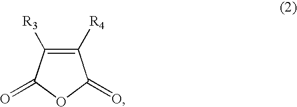
wherein:
R₃ and R₄ are the same or different,
R₃ is hydrogen, halogen, or C₁-C₁₀ alkyl, C₁-C₁₀ alkenyl or C₁-C₁₀ alkoxy, each unsubstituted or substituted with at least one halogen, and
R₄ is hydrogen, halogen, or C₁-C₁₀ alkyl, C₁-C₁₀ alkenyl or C₁-C₁₀ alkoxy, each unsubstituted or substituted with at least one halogen.

15. The battery as claimed in claim 11, wherein the one or more trialkylsilyl borate compounds includes trimethylsilyl borate.

16. The battery as claimed in claim 11, wherein a ratio of a total weight of the one or more succinic acid anhydride compounds to a total weight of the one or more trialkylsilyl borate compounds is about 1:1.

17. The battery as claimed in claim 11, wherein the organic solvent includes one or more of dimethyl carbonate, diethyl carbonate, ethylpropyl carbonate, dipropyl carbonate, methylethyl carbonate, methylpropyl carbonate, ethylene carbonate, propylene carbonate, butylene carbonate, and/or vinylene carbonate.

18. The battery as claimed in claim 17, wherein the organic solvent further includes one or more of an ester-based solvent, an ether-based solvent, a ketone-based solvent and/or an aromatic hydrocarbon solvent.

19. The battery as claimed in claim 11, wherein a ratio of a weight of the organic solvent to a total weight of the one or more succinic acid anhydride compounds and the one or more trialkylsilyl borate compounds is about 0.01:100 to about 10:100.

20. The battery as claimed in claim 11, wherein the lithium salt is present in a concentration of about 0.6 M to about 2.0 M with respect to the organic solvent.
